(19) United States
(12) Patent Application Publication
(10) Pub. No.: US 2020/0131068 A1
(43) Pub. Date: Apr. 30, 2020

(54) CLARIFYING, FILTERING AND DISINFECTING PROCESSING WATER FOR REUSE

(71) Applicant: AHPharma, Inc., Hebron, MD (US)

(72) Inventors: James L. McNaughton, Quantico, MD (US); Michael Barnas, Delmar, MD (US); Stephen King Auman, Spring Hill, FL (US); Aaron Redden, Girdletree, MD (US); Michael Roberts, Quantico, MD (US)

(21) Appl. No.: 16/664,232

(22) Filed: Oct. 25, 2019

Related U.S. Application Data
(60) Provisional application No. 62/750,350, filed on Oct. 25, 2018.

(51) Int. Cl. C02F 9/00; A22C 21/04

(52) U.S. Cl. CPC C02F 9/00; C02F 1/5236; A22C 21/04

(57) ABSTRACT

Wastewater may be reconditioned for re-use in a food processing line. The wastewater is subjected to coarse particle separation on the wastewater to create first stage water, after which large and small particles in the first stage water are separated in a liquid waste separator to create a second stage water. The second stage water is directed to a flocculation settling tank to aggregate remaining solids, and the remaining solids are removed to create a third stage water. Finally, the third stage water is treated with at least one of UV light and chemical antimicrobials to create reusable water. The reusable water is delivered upstream to reduce fresh water requirements. Ferrate (IV) is an exemplary antimicrobial that has broad applications in the food processing line.

### CROSS-REFERENCES TO RELATED APPLICATIONS

This application claims the benefit of U.S. Provisional Patent Application No. 62/750,350, filed Oct. 25, 2018, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to food processing wastewater and, more particularly, to recycling food processing water for reuse at various stages of a food processing cycle.

Food processing plants employ a large amount of water for washing, waste fluming, scalding, chilling, post-chilling, and clean-up; employing both hot and cold water. Traditionally, this water is used once and discarded. However, rising operating costs attributed to water consumption and disposal have caused food processors to evaluate methods of reusing water within the current guidelines set forth by the United States Department of Agriculture (USDA) under 9 CFR 416.2 (g)(3). According to this regulation, “water, ice, and solutions used to chill or wash raw product may be reused for the same purpose provided that measures are taken to reduce physical, chemical, and microbiological contamination so as to prevent contamination or adulteration of product.” To reduce physical, chemical and microbiological contamination, USDA FSIS recommends the use of filtration as well as antimicrobial interventions such as UV light, antimicrobial chemical, or ozonation.

A significant amount of money can be saved by recycling some or all the wastewater streams and reducing the overall fresh water usage. Considering 9 billion broilers are processed annually, and each bird is processed using 5-10 gallons of water, the domestic poultry industry consumes 45-90 billion gallons of water annually. The reported cost of this water ranges from 2.55-6.13 cents per bird depending upon geographical region. Recycling even 1% or less of processing water could result in millions of gallons of water, and therefore, dollars saved annually. Additional savings may also be attained through reduction in total refrigeration load and discarded product due to contamination.

There are many guidelines and regulations controlling the reuse of waste chill and scald water globally. In the United States of America, USDA FSIS states that “Section 416.2(g)(3) does not dictate what measures need to be taken, only that measures be taken to reduce physical, chemical, and microbiological contamination so as to prevent contamination or adulteration of product. The extent of reconditioning is dependent on the source of the water and the specific reuse application. Each situation should be considered in the hazard analysis for the particular process, and the necessary measures to prevent contamination or adulteration of product should be identified.”

Laboratory tests have shown that contaminated overflow water from poultry processing chill and scald tanks is comprised of fats, oils, grease, and microorganisms that go into suspension when the carcass is moved through the cooling tank. Total suspended solids are typically in the 600-800 ppm range, of which 30% are large floating particles of grease and fat. Most suspended solids (55% from 20-5 micron) form an opaque haze believed to be emulsified oils of entrapped proteins and lipids together with microorganisms. The remaining contaminants are thought to be less than 5 microns in size and are even more tightly bound emulsified globules.

Research has shown that the level of microbes per carcass increases during processing, which is often attributed to cross-contamination along belts and other processing equipment. Therefore, reconditioning processing water to remove small particles containing microorganisms could benefit processors in several ways. First, the removal of microorganisms from chill and scald water will reduce the initial microbial load on the carcass, limiting the potential for cross contamination. Additionally, reconditioning wastewater allows processors to employ more water (higher volume and higher pressure) for cleaning belts and other equipment without the need to pay for fresh water to be sourced then disposed of.

Although there are numerous ways to treat food processing water, many are not economical or have other negative attributes that inhibit their widespread use. To be widely implemented, a solution must be economical, effective, reliable, easily monitored, and avoid the use of additional chemicals.

Historically, several methods have been employed within the food processing industry to no avail. Dissolved air flotation (DAF) systems are effective at reducing the solids in wastewater yet require a disposable filter and more labor and maintenance than processors are willing to accept. Ozonation has been used in conjunction with DAF, but the high levels of organic matter reduce the efficacy of ozone and require inclusions levels beyond economical limits. Chemicals such as flocculants have been employed with some success but must be removed prior to reuse so as not to be considered a “Food Additive.” This drawback of complete removal also applies to residual ozone and filter aids.

More recently, Peracetic acid (PAA) has been used extensively as a sanitizer, disinfectant, and sterilant during animal processing. PAA is used extensively in the food processing industry with concentrations of 50 to 2000 ppm permitted. PAA destroys microbes and appears to leave no residue but may be dangerous to employees working with the chemical. PAA can cause noticeable irritation to the skin and eyes. Signs and symptoms of acute ingestion of peracetic acid may include corrosion of mucous membranes of mouth, throat, and esophagus with immediate pain and dysphagia (difficulty in swallowing); ingestion may cause gastrointestinal tract irritation. Additionally, with the increased inclusion rates of PAA due to the high organic load, concern for developing resistant strains of bacteria have arisen.

Acidified sodium chlorite has been approved by the U.S. Food and Drug Administration (FDA) as an antimicrobial agent approved for the treatment of processed poultry, red meat (beef, pork, and sheep), seafood, fruits and vegetables. Studies have demonstrated that acidified sodium chlorite is an effective inhibitor of E. coli on poultry carcasses when used in a pilot test as a spray or dip application at 1,200 ppm sodium chlorite. Additionally, disinfection with acidified sodium chlorite was accomplished by including a spray cabinet on the processing line just after the carcass washing station and immediately prior to the chiller. Fecal and digesta contaminated carcasses were then permitted to remain online to transit through the inside-outside-bird-washer (IOBW), then the acidified sodium chlorite spray cabinet, before finally dropping off into the chiller. This system is referred to as continuous online processing (COP) because the combination of IOBW and the disinfection process eliminates the need for removal of contaminated carcasses from the shackle line for special treatment.

To treat the problem associated with nearly all currently employed disinfection products, most of the large and small solids must be removed from the processing water prior to chemical treatment. To achieve this, large particles ( 1/32″ and larger) must first be removed prior to a microfiltration process where small particles including pathogens and emulsified oils are collected and disposed of.

This invention includes a series of progressive physical interventions that remove deleterious compounds found in processing wastewater and avoid the deficiencies described above.

### SUMMARY

The invention covers a process for reconditioning chilled wastewater that includes a series of automated interventions that progressively remove both large and small particles. The dedicated equipment used to remove these particles includes initial coarse particle separation using a trommel screen, followed by a hydrocyclone clarifier which then pushes water into a flocculant treatment settling tank with skimmer to remove the floc and conical bottom to remove sediments, which are then recycled back to the hydrocyclone clarifier for reprocessing. Flocculation tank overflow would then be collected in a centrifuge feed tank with any solids returned to the flocculation tank. The final step includes sanitation of the clarifier liquor using low inclusion levels of existing chemical treatments such as PAA for the reconditioned wastewater to become potable water.

The system and methods of the described embodiment also endeavor to utilize Ferrate(VI) for disinfection, chemical oxidation and coagulation water treatment processes.

In an exemplary embodiment, a method of treating and reusing wastewater for food processing includes the steps of (a) conducting a coarse particle separation on the wastewater to create first stage water; (b) separating large and small particles in the first stage water in a liquid waste separator to create a second stage water; (c) directing the second stage water to a flocculation settling tank to aggregate remaining solids, and removing the remaining solids to create a third stage water; and (d) treating the third stage water with at least one of UV light and chemical antimicrobials to create reusable water.

Step (a) may be practiced by trammel screening and floatation. Step (b) may be practiced using a series of the liquid waste separators. Step (b) may be practiced with the series of the liquid waste separators using progression in a ratio of centripetal force to fluid resistance.

Step (c) may be practiced using ferric chloride, where the remaining solids either precipitate to a bottom of the flocculation settling tank or float to surface for removal by a skimmer. Step (d) may be practiced using a centrifugal pump to recirculate the third stage water into a disinfecting tank for treatment. After step (d), the reusable water may be directed to at least one of a chill tank, a post-chill tank, and a scalding tank. Step (d) may be practiced using peracetic acid in a concentration of 50 ppm.

Step (c) may include using Ferrate (Fe(VI)) to flocculate the remaining solids and to disinfect the second stage water. Step (d) may be practiced using Fe(VI).

In another exemplary embodiment, a method of processing poultry and of treating and reusing wastewater from poultry processing includes the steps of: (a) immersing the poultry in a scald tank; (b) removing feathers of the poultry in a picker; (c) cleaning and processing the poultry; (d) immersing the poultry in a chill tank; and (e) further processing the poultry for packaging. Wastewater from at least one of steps (a), (c), (d) and (e) is treated by: (i) conducting a coarse particle separation on the wastewater to create first stage water, (ii) separating large and small particles in the first stage water in a liquid waste separator to create a second stage water, (iii) directing the second stage water to a flocculation settling tank to aggregate remaining solids, and removing the remaining solids to create a third stage water, and (iv) treating the third stage water with at least one of UV light and chemical antimicrobials to create reusable water. The reusable water is recirculated for use in at least one of steps (a), (c), (d) and (e).

The Fe(VI) may be mixed with the third stage water in a concentration of 500-1500 ppm.

The method may also include applying Fe(VI) directly to the poultry in at least one of steps (a), (c), (d) and (e).

### BRIEF DESCRIPTION OF THE DRAWINGS

These and other aspects and advantages will be described in detail with reference to the accompanying drawings, in which:

FIG. 1 is a flow diagram showing the methodology for reconditioning wastewater; and

FIG. 2 is a system and process diagram showing an exemplary application for reconditioned wastewater.

### DETAILED DESCRIPTION

Water runoff can be captured at various stages of a food processing line. The systems and methods of the described embodiments recondition the runoff wastewater, and the reconditioned water is suitable for use in upstream processes. The systems and methods will be described in the context of poultry processing, but the methodology of the invention is readily suitable to other types of food processing such as swine, beef, seafood, and fresh produce.

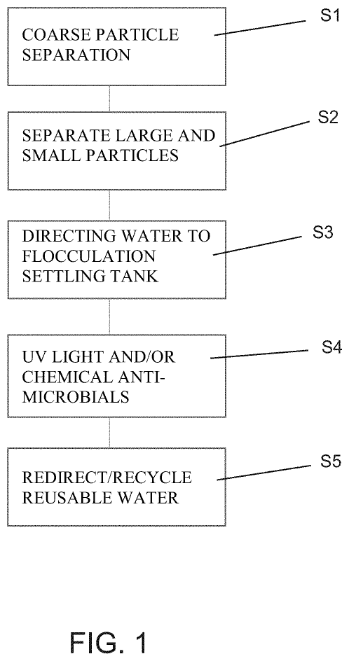

Wastewater runoff generally contains organic material comprised of two separate components: (1) large lumps of fat and grease, and (2) emulsified globules. Treatment and removal is performed in two distinct processes. With reference to FIG. 1, the wastewater is initially processed via an initial coarse particle separation using a trommel screen (step S1) to create a first stage water. Particles which remain in suspension will be carried to an intervention, which includes a series of self-cleaning hydrocyclone clarifiers designed to separate both large and small particles using a progression in the ratio of centripetal force to fluid resistance to create a second stage water (step S2). Hydrocyclone clarifiers will run in series continuously yet could run independently when a single unit must be taken offline for maintenance.

After the wastewater stream is processed by the hydrocyclone clarifiers to create the second stage water, the second stage water will be carried to a flocculation settling tank with skimmers (step S3) to create a third stage water. Economical flocculants such as ferric chloride could be employed during this step to aggregate remaining solids and either precipitate to the conical bottom where they will be removed and sent back to the hydrocyclone clarifier, or float to the surface where they will be removed via skimmer and sent back to the hydrocyclone for reprocessing.

Flocculation tank overflow of the third stage water would then be sent to the final filtration intervention, which involves the use of a centrifugal pump to recirculate water into a disinfecting tank where it will be treated with UV light and existing chemical antimicrobials such as PAA or free chlorine or the like to create reconditioned of reusable water (step S4). The reconditioned water would then become potable and could be reused for processing within the USDA guidelines described in 9 CFR 416.2 (g)(3) (step S5).

Ferrate(VI) chemistry is currently an active area of research. The chemistry of oxo complexes of iron has demonstrated remarkable applications of Ferrate(VI) as a highly potent bacteriocide and environmentally friendly oxidant for destruction and removal of organic and inorganic toxins. The “intriguing” reaction pathways of “self-decay” of highly oxidized iron has no known parallel for the observed phenomenon of the formation of molecular oxygen “by oxidation of water.” It is reported that the high level of ionization energy (556 eV) for the (FeO₄)⁻² anion cannot be compensated by the ionic and covalent binding energies with the four O₂ ligands. More research is required to determine reliable models for molecular and electronic structure of Ferrate oxidation states and condensation reactions before Ferrate(VI) disinfection activity can be understood completely.

Disinfection, Chemical Oxidation and Coagulation are critical processes in water treatment that can all be achieved with the use of Ferrate(VI). In aqueous solutions, Ferrate(VI) disinfects by releasing reactive oxygen and OH− radicals that kill organisms harmful to human health such as bacteria and viruses. The reduction pathway of Ferrate(VI) to Fe(III) drives chemical oxidation of both organic (lipids, proteins, humates, bacteria) compounds and eliminates odors by oxidizing organic and inorganic compounds (Acetic Acid and sulfur and nitrogen). Reduced Ferrate(III) hydroxide reacts with non-settling suspended particles so that they hydrate and attach to each other. Adsorbed fats and proteins form colloidal particles that can be removed by clarification/filtration processes. Treated wastewater can then be recycled, displacing some of the fresh makeup water in the initial wash operation.

In aqueous solutions, the Ferrate(VI) condensation pathway leads to reduced forms Fe(III) hydroxide and Fe(II) oxide. The majority of the decay reactions lead to hydrogen peroxide and gaseous oxygen along with hydroxyl anion from both reduced Ferrate(III) and dissociated water. It is proposed that these anions act simultaneously in wastewater treatment/purification systems to effect oxidation of inorganic and organic matter, destroy cellular membranes, and adsorb/coagulate solids. There are no harmful by-products from Ferrate(VI) applications, and it is therefore considered a “green” environmentally friendly chemical.

EPA has approved the use of Ferrate(VI) for disinfection and clarification of potable municipal wastewater systems. Chemical inputs (Ferric chloride, Sodium hypochlorite, and sodium hydroxide) are currently approved for use in municipal treatment facilities. Ferrate chemical reaction products are non-toxic products: sodium Ferrate(VI), sodium chloride (salt) and water. Ferrate(VI) degradation products of Ferric chloride and Ferric(III) hydroxide adsorb/coagulate and precipitate solids, including killed pathogens, are non-toxic and can be disposed of as filtered sediments. Moreover, in contrast with PAA, Ferrate has no inherent smell or fumes, and a benefit for processing plants will be the ability to use Ferrate (potentially at very high concentrations) at various critical control points proximal to workers without resulting in a hazardous work environment.

The oxidation-reduction capacity of Ferrate(VI) has been shown to be superior to all other commercial chemical oxidizers and disinfectants used in water and wastewater treatment. When Ferrate(VI) salts dissolve in water, the release of oxygen and formation of its reduced form Fe(III) as iron hydroxide, simultaneously disinfect, oxidize, and coagulate dissolved solids.

The term Ferrate is normally used to refer to Ferrate(VI) six valence iron (IUPAC name Ferrate(VI) or Tetraoxyironbis(olate)) although it can be used to refer to other iron containing anions salts. The most common Ferrate(VI) salt is sodium or potassium Ferrate (FeO₄)⁻². Ferrate salts can be synthesized (1) by the wet method reacting tri-valent iron in an aqueous medium under strong alkalizing conditions, (2) in the solid state by heating a mixture of iron filings and powdered potassium nitrate, and (3) by electro-chemical ionization using an iron/platinum cathode/anode connected to an electrical current source placed in a caustic electrolyte solution.

The most practical form of Ferrate(VI) currently used in wastewater treatment is sodium Ferrate salt. It is a water soluble form of Ferrate(VI) that can be produced as a high purity concentrate.

Ferrate(VI) can be produced from relatively inexpensive commercial chemicals—trivalent Ferric Chloride (FeCl₃), sodium hypochlorite (NaOCl) and sodium hydroxide (NaOH). Reactant products are: Sodium Ferrate (Na₂FeO₄), Sodium Chloride Salt (NaCl), Ferric Hydrate (Fe(OH)₃) and water.

It has been shown that Ferrate(VI) is a powerful chemical technology for disinfection, chemical oxidation, and coagulation of waste-water treatment systems. It is proposed that use of Ferrate(VI) in a Poultry Waste-Water system has the following advantages/disadvantages over current chemical treatment technologies:

| Oxidant and | | |
|---|---|---|
| Disinfection | Advantages | Disadvantages |
| Ferrate(VI) | (i) Excessive capacity of | (i) Low Ferrate(VI) |
| | Oxidation; | production rate; |
| | (ii) non-toxic byproducts; | (ii) lack of stability for |
| | (iii) ability of colloidal | long term storage. |
| | particles coagulation; | |
| | (iv) ability for long term | |
| | storage disinfection, | |
| | oxidation, and coagulation | |
| | simultaneously; | |
| | (v) needing smaller | |
| | wastewater treatment plant; | |
| | (vi) low application cost; | |
| | and | |
| | (vii) ability of inorganic | |
| | and heavy metal removal. | |
| Fe(III) | (i) Low residue after | (i) Producing non-soluble |
| | coagulation process; | solids in water; and |
| | (ii) high efficiency for | (ii) alkaline compounds |
| | colloidal particles removal; | usually added for better |
| | (iii) effective on pHs from | performance. |
| | 4 to 6 and 6.6 to 9.2; and | |
| | (iv) low cost. | |

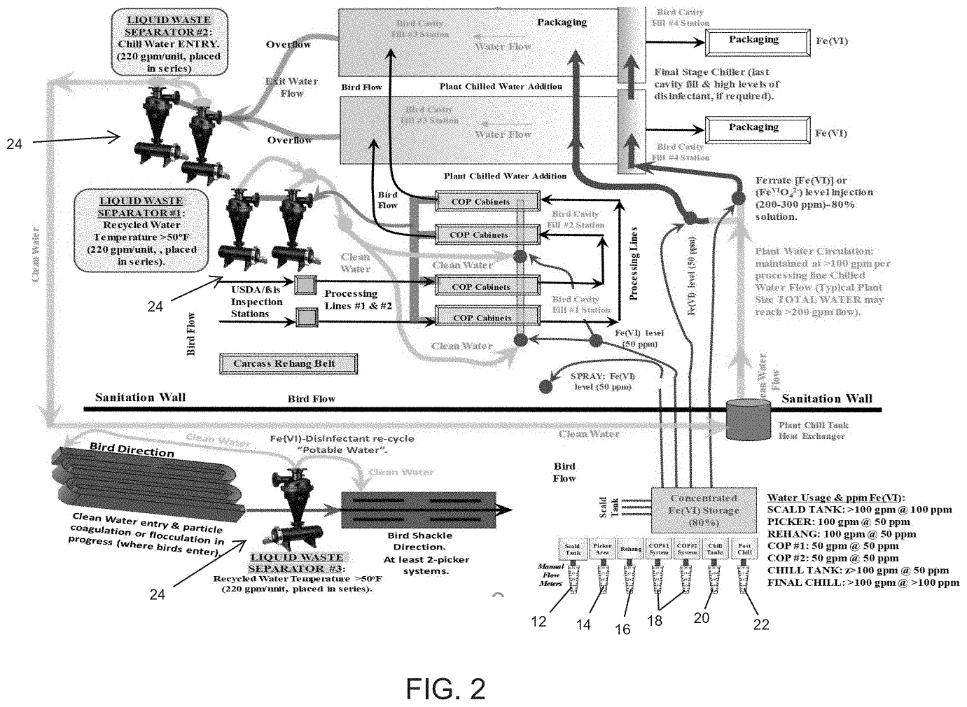

FIG. 2 is an exemplary system diagram showing the use of reconditioned wastewater in a poultry processing system. Generally, after slaughtering, the birds are immersed in a scald tank 12, which serves to help loosen feathers. Feather removal is performed in a picker 14, and the birds are rehung for evisceration 16. In various processing stages 18, the birds are further cleaned and sprayed with disinfectant and the like. Subsequently, the birds are immersed in a chill tank 20, and the birds are then further processed for packaging 22. Exemplary water usage at each phase is shown in FIG. 2.

FIG. 2 shows a plurality of liquid waste separators 24 that are positioned at various stages in the line. Each of the liquid waste separators 24 receives wastewater from one or more of the noted processes and performs the noted steps S1-S5 from FIG. 1. At least steps S3 and S4 may utilize Ferrate(VI) to both flocculate solids and disinfect the water. The liquid waste separators 24 are placed at different points in the processing plant to create a side-stream of water that is cleaned up and used backwards somewhere in the processing.

In some embodiments, Ferrate(VI) is incorporated into the existing processing line using high-pressure nozzles spraying directly onto carcasses pre- and post-evisceration. A direct application of Ferrate is also potentially applicable in the chill tank 20 and/or the post-chill processing 22 for cut-up parts or whole carcasses. Existing systems utilize cold water with high levels of chemicals like PAA to chill the carcass and provide final disinfection prior to packaging. High levels of PAA, however, are detrimental to the final product by removing fat from the carcass, reducing yield and adding organic matter to the wastewater. Ferrate is more stable at lower temperatures than high temperatures and will not result in fat being separated from the carcass.

The Ferrate process of the described embodiments was developed from an extensive literature search of scientific papers on Ferrate chemistry and practical applications to commercial production. Development of the process considered use of many iron based starting materials and oxidants to drive the reaction, as well as pH and pKa considerations for Ferrate product stability. More development of the process chemistry is planned to improve commercial production and application of Ferrates in food disinfection applications. For example, Ozone may act as another (more expensive) oxidant to push further conversion of Fe3+ to Fe6+.

The described system is designed to be implemented alongside existing processing equipment without the need for excess fabrication or disruption of standard processing practices. Because of the cost-effective nature of the system, redundant equipment will be implemented at each step to allow for continuous online processing even when a single piece of equipment must be isolated and taken offline for cleaning, maintenance, or replacement.

In addition to cleansing water for reuse within the chill, post-chill or scalding tank, an additional use for the reconditioned wastewater could be to increase the amount of pressure and volume of water that is used to cleanse the carcass or product during washing, rinsing, scalding, feather or hair removal, evisceration, transportation along belts/ramps, chilling, and post-chilling. Additionally, this reconditioned water could be used to clean equipment or the facility itself within the guidelines of 9 CFR 416.2 (g)(3) to reduce the overall likelihood of cross-contamination.

An additional benefit of the invention is that it enhances the natural disinfecting power of commonly used chemicals. For example, poultry processors currently use upwards of 1200 ppm of PAA in the chill tank to reduce microbes because the efficacy is greatly decreased by the large organic load. However, with a lower level of organic material present in the wastewater, PAA is effective at 50 ppm. This invention would allow processors to use less chemicals while still achieving the same or even enhanced antimicrobial activity. Not only would this save money on the chemicals themselves, but it also decreases the chances of any occupational health hazards for employees who encounter the chemicals daily.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of treating and reusing wastewater for food processing, the method comprising:
(a) conducting a coarse particle separation on the wastewater to create first stage water;
(b) separating large and small particles in the first stage water in a liquid waste separator to create a second stage water;
(c) directing the second stage water to a flocculation settling tank to aggregate remaining solids, and removing the remaining solids to create a third stage water; and
(d) treating the third stage water with at least one of UV light and chemical antimicrobials to create reusable water.

2. A method according to claim 1, wherein step (a) is practiced by trammel screening and floatation.

3. A method according to claim 1, wherein step (b) is practiced using a series of the liquid waste separators.

4. A method according to claim 3, wherein step (b) is practiced with the series of the liquid waste separators using progression in a ratio of centripetal force to fluid resistance.

5. A method according to claim 1, wherein step (c) is practiced using ferric chloride, wherein the remaining solids either precipitate to a bottom of the flocculation settling tank or float to surface for removal by a skimmer.

6. A method according to claim 1, wherein step (d) is practiced using a centrifugal pump to recirculate the third stage water into a disinfecting tank for treatment.

7. A method according to claim 1, wherein after step (d), the reusable water is directed to at least one of a chill tank, a post-chill tank, and a scalding tank.

8. A method according to claim 7, wherein step (d) is practiced using peracetic acid in a concentration of 50 ppm.

9. A method according to claim 1, wherein step (c) comprises using Ferrate (Fe(VI)) to flocculate the remaining solids and to disinfect the second stage water.

10. A method according to claim 1, wherein step (d) is practiced using Fe(VI).

11. A method of processing poultry and of treating and reusing wastewater from poultry processing, the method comprising:
(a) immersing the poultry in a scald tank;
(b) removing feathers of the poultry in a picker;
(c) cleaning and processing the poultry;
(d) immersing the poultry in a chill tank; and
(e) further processing the poultry for packaging, wherein wastewater from at least one of steps (a), (c), (d) and (e) is treated by:
(i) conducting a coarse particle separation on the wastewater to create first stage water,
(ii) separating large and small particles in the first stage water in a liquid waste separator to create a second stage water,
(iii) directing the second stage water to a flocculation settling tank to aggregate remaining solids, and removing the remaining solids to create a third stage water, and
(iv) treating the third stage water with at least one of UV light and chemical antimicrobials to create reusable water, and
wherein the reusable water is recirculated for use in at least one of steps (a), (c), (d) and (e).

12. A method according to claim 1, wherein step (iii) comprises using Ferrate (Fe(VI)) to flocculate the remaining solids and to disinfect the second stage water.

13. A method according to claim 1, wherein step (iv) is practiced using Fe(VI).

14. A method according to claim 13, wherein the Fe(VI) is mixed with the third stage water in a concentration of 500-1500 ppm.

15. A method according to claim 11, further comprising applying Fe(VI) directly to the poultry in at least one of steps (a), (c), (d) and (e).

16. A method according to claim 11, wherein steps (i)-(iv) are practiced in the liquid waste separator.
